(19) United States
(12) Patent Application Publication
(10) Pub. No.: US 2015/0363092 A1
(43) Pub. Date: Dec. 17, 2015

(54) SYSTEMS AND METHODS FOR COLLABORATIVE ELECTRONIC COMMUNICATIONS

(71) Applicant: Contatta, Inc., Scottsdale, AZ (US)

(72) Inventor: Michael Morton, Scottsdale, AZ (US)

(21) Appl. No.: 14/724,798

(22) Filed: May 28, 2015

Related U.S. Application Data
(60) Provisional application No. 62/005,125, filed on May 30, 2014.
(60) Provisional application No. 62/157,535, filed on May 6, 2015.

(51) Int. Cl. G06F 3/0484; H04L 12/58

(52) U.S. Cl. CPC G06F 3/04847; G06F 3/04842; H04L 51/046

(57) ABSTRACT

Systems and methods for collaborative electronic communications are presented. One or more messages within a collaborative electronic communication platform, such as emails or chat messages, can be selected for further action. Messages such as chat messages within a chronological, multi-user chat stream can be selected for generation of an associated post content item. Content from the selected messages may be automatically inserted into the generated post. The post may be displayed together in a content group along with discussion or other further content contributions. Multiple posts and their content groups may be displayed in sequence by post date or date of last content contribution. Messages may also be selected for generation of an associated task item within a task management platform. In a chat platform, multiple non-adjacent messages may be selected for generation of a single task item. Generated posts or tasks may incorporate default information extracted from their associated messages.

### TECHNICAL FIELD

The present disclosure relates in general to Internet-based collaboration and communication, and in particular to systems and methods for cloud-based collaborative email, communications, contacts management, task management and file management.

### BACKGROUND

Electronic communication is a method for exchanging digital messages and information amongst multiple individuals. Electronic communication may operate across the Internet or other electronic communication networks. Examples of electronic communication include email, online chat, Short Messaging Service (SMS) communication, and Multimedia Messaging Service (MMS) communications.

Electronic communications have become a primary method by which people communication information. Email in particular has become indispensible. Particularly in business settings, people use email for a variety of purposes, including one-on-one communication, group collaboration, file storage, contacts management, scheduling mechanism and de facto task list. While email is highly versatile, prior art email systems are not always well-suited to the tasks to which they are put. Many people have become overwhelmed by the volume of email they receive. They spend an inordinate amount of time reading, filing, responding to, and otherwise processing email messages.

Conventionally, contact management systems have been implemented separately from email systems. A user may primarily utilize an email client for email activity, such as Microsoft Outlook or a webmail client. A separate system may implemented for contact management or client relationship management (“CRM”). Because so much of modern communications take place via email, prior systems typically include some form of integration between the mail system and contact management system. For example, Outlook plugins may enable direct conveyance of data between an end user's email client and a centralized, shared contact management system. Alternatively, prior art systems may have included manual or automatic forwarding of copies of emails to a contact management system, for parsing and association of email content with contact records.

Recently, individuals have been increasingly shifting their communications towards various near-real-time, ad hoc messaging platforms such as SMS, Apple™ iMessage, or various chat services based on the Extensible Messaging and Presence Protocol (XMPP). Communications via such chat platforms are typically characterized by random, asynchronous communications amongst two or more users. Chat communications are typically mixed within a stream of communications, and not systematically organized or separated by topic.

One challenge faced by users of chat-based communication systems is organization of information. The ad hoc nature of chat communications, in which communications from numerous individuals regarding numerous topics can be woven together in a chronological stream of communications, can make it particularly challenging to locate, organize or synthesize information. Various solutions have been developed in an attempt to facilitate location of relevant information from amongst a stream of chat communications. One such example is the use of hashtag labels. Hashtag labels are inserted into messages by message authors. Users can then use the hashtag labels as search criteria to identify content contributions that have been self-identified by their authors as sharing a particular topic or characteristic.

### SUMMARY

The present disclosure describes systems and method for collaborative electronic communications. In accordance with one aspect, a method is performed by a user computing device interaction with a user. The method involves generating, for presentation on the computer system, visual indicia of a plurality of messages within a chat message stream. A first user interface element is generated for presentation by the computer system, which when selected by the user, enables the user to identify one or more messages within the chat message stream for further action. In some embodiments, the user can identify multiple non-adjacent messages within the chat stream. Selection of a second user interface element by the user is detected to cause the computer system to initiate the generation of a post content item. The post content item may be associated with further content contributions contributed by the user and/or other users. The post content item contains content from the one or more identified messages. The computer system then displays a content group comprising the post content item. The displayed content group may include the post content item as well as the comments, discussion or other associated further content contributions. Multiple post content groups may be displayed, sequenced, e.g., in order of most recent post content item creation or most recent further content contribution.

In accordance with another aspect, a method is provided by which a user computing device interacts with a user to facilitate electronic communications with other individuals. The user computing device generates visual indicia of messages within an electronic communication system. A first user interface element is presented which, when selected by the user, enables the user to select a message. Generation of a task item associated with the selected message is then initiated. The task item may include a plurality of information fields, some of which may be populated with default information associated with the selected message, such as content from the body of the selected message. In some embodiments, the messages are email messages. In some embodiments, the messages are chat messages, and the user may select multiple messages from a chat stream which are associated with the new task item and from which default task field information can be extracted.

In accordance with another aspect, systems for electronic communication may be hosted on one or more servers communicating with a plurality of user devices. In some embodiments, a chat service and a content item posting service are hosted. User input may be received specifying one or more messages within the chat stream (potentially including multiple non-adjacent messages), and a request for generation of a new post. The servers then generate a new post within the content item posting service, containing content from the one or more specified messages. Generation of the new post content item may include transmitting an opening new post form prepopulated with content associated with the one or more specified messages, receiving a commited new post form, and using content within the committed new post form to generate the new post.

In other embodiments, a plurality of electronic messages are stored. User input is received from a first user via communication between a user device associated with said first user and one or more of said servers, the user input to include specification of one of said plurality of electronic messages and a request for generation of a new task item. In response to receiving the user input, a task item is generated within a task management service, the task item being associated with the selected message. The task item may include a plurality of information fields, some of which may be prepopulated with default information associated with the selected message, such as the body of the selected message. In some embodiments, the messages may be email messages. In other embodiments, the messages may be chat messages, a plurality of which are selected from a chat stream and utilized to generate a task item associated with each of the plurality of selected messages.

Various other objects, features, aspects and advantages of the present disclosure will become apparent from the following detailed description, along with the accompanying drawings.

### BRIEF DESCRIPTION OF THE FIGURES

FIG. 1 is schematic block diagram of a prior art communications system.

FIG. 2 is schematic block diagram of a prior art database configuration.

FIG. 3 is a schematic block diagram of a collaboration platform.

FIG. 4 is a schematic block diagram of a database.

FIG. 5 is a user interface of an email account for a first user, in accordance with one aspect of the disclosed embodiments.

FIG. 5B is a user interface of an email account for a second user.

FIG. 6 is a further email user interface illustration for the first user.

FIG. 7 is a further email user interface illustration for the first user.

FIGS. 8A, 8B, 8C and 8D are schematic block diagrams of a PC sliding panes user interface mechanism, in accordance with another aspect of the disclosed embodiments.

FIGS. 9A, 9B, 9C and 9D are schematic block diagrams of a tablet computer sliding panes user interface mechanism.

FIG. 10 is a user interface illustration of an email client implemented using a sliding panes user interface.

FIG. 11 is a top tab-based user interface rendered by the system of FIG. 10 after navigating away with uncommitted form data.

FIG. 12 is a side tab user interface rendering of the system of FIG. 10 after navigating away with uncommitted form data.

FIG. 13 is a user interface illustration associated with initiating a task creation from an email message.

FIG. 14 is a schematic block diagram of a computing environment in which a collaboration platform with chat messaging can be implemented.

FIG. 15 is a schematic block diagram of a user device that can be utilized within the environment of FIG. 14.

FIG. 16 is a user interface that can be presented through interaction of user devices with an embodiment of the collaboration platform.

FIG. 17 is a schematic block diagrams of a group chat message stream.

FIG. 18 is a schematic block diagram of a group chat message stream.

FIG. 19 is a flow chart of a process for generating a post from one or more chat messages.

FIG. 20 is a user interface that can be presented through interaction of user devices with an embodiment of the collaboration platform, in which multiple chat stream messages can be selected for promotion to a post.

FIG. 21 is a user interface that can be presented through interaction of user devices with an embodiment of the collaboration platform, in which multiple chat stream messages have been promoted to a post.

FIG. 22 is a user interface for creating a task from selected messages.

FIG. 23 is a user interface that can be presented through interaction of user devices with an embodiment of the collaboration platform, enabling direct private chat.

### DETAILED DESCRIPTION

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

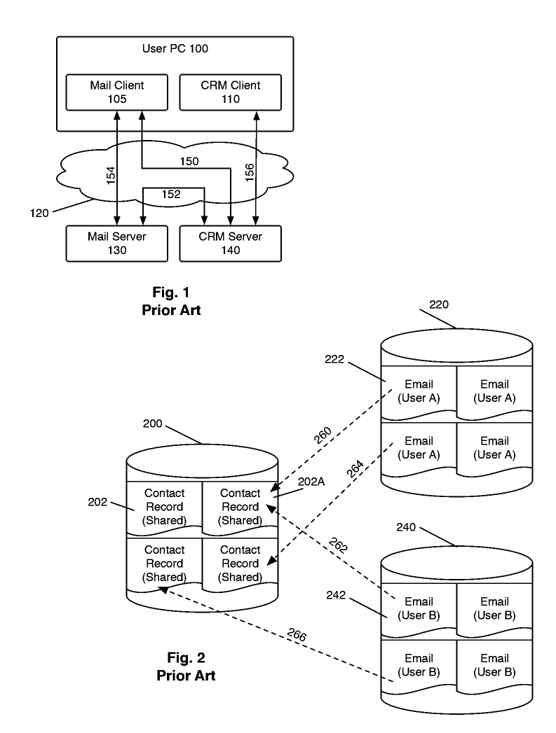

FIG. 1 illustrates such a prior art implementation of email with a shared contact management platform. User computer 100 includes email client application 105 and CRM client application 110. Mail client 105 communicates primarily with mail server 130 via network connection 154 and data network 120, which may be the Internet. CRM client 110 communicates with CRM server 140 via network connection 156 and data network 120. In some implementations, mail client 105 may utilize data connection 150 to communicate directly with CRM server 140. This situation may arise, for example, in an embodiment in which Microsoft Outlook is utilized as mail client 105, and a custom software plug-in is provided in order to extend the functionality of Microsoft Outlook to convey data to and/or from CRM server 140. Alternatively or additionally, data may be conveyed directly between mail server 130 and CRM server 140 via data connection 152. For example, mail server 130 may be configured to automatically forward copies of emails to CRM server 140, so that CRM server 140 can parse each email and associate it with known contact records within CRM server 140.

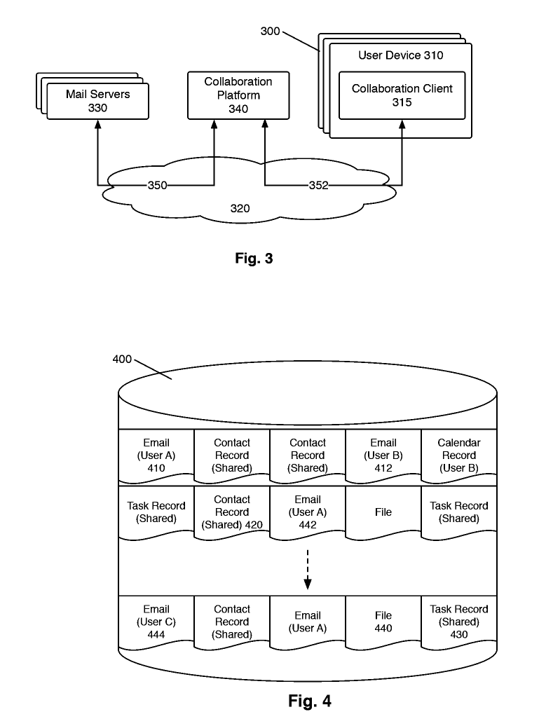

FIG. 2 illustrates an exemplary prior art database implementation, with integration between mail and CRM systems occurring via cross referencing separately maintained databases. Database 200 is maintained within CRM server 140, and stores records 202 associated with contacts. Such contact records may contain information such as first name, last name, company, phone numbers, email addresses, physical addresses, notes, and other pertinent information. In some embodiments contact records 202 may each be deemed “shared” or “private”, where shared records are accessible to multiple users or potentially all users of the contact management system, and access to private records is restricted to one or more specific users of the system. In the prior art system of FIG. 2, email is stored in one or more separate databases. Specifically, database 220 is maintained within mail server 130 or a first user's mail client, and contains email records 222 associated with a first user referred to in the drawing as User A, while database 240 (stored within a second user's mail server or email client) contains email records 242 associated with a second user referred to in the drawing as User B. In some prior art embodiments, email records associated with a particular user may be stored in a data store separate from that containing email records associated with other users. In other prior art embodiments, a global email data store is maintained, containing email records from a plurality of users. Regardless, email records are known to be associated with contact records via references between separate databases. For example, contact record 202A was a recipient of email 222 and email 242; accordingly, email 222 is associated with contact record 202A via reference 260, and email 242 is associated with contact record 202A via reference 262.

The separate data stores of FIG. 2 lend themselves to implementations where one or more standalone email systems is integrated with a contact management system. However, the implementation of FIG. 2 requires constant maintenance of record references such as references 260 and 262. Each time an email is added to, deleted from or moved within an email database, emails must be parsed and references with the contact database must be regenerated. Likewise, when a contact is deleted from database 200, the system must audit references to identify those outdated. If a contact is added to database 200, the system must parse all emails within databases 220 and 240 in order to generate any new references that are appropriate. While the prior art referenced structures of FIGS. 1 and 2 enable integration between an email system and a contact management system, record reference maintenance may be a high-overhead activity prone to error or delay.

FIG. 3 illustrates an embodiment of an alternative communications system architecture, which integrates email communications with a shared contacts database. Collaboration platform 340 is a unified system implementing multiple functions that enable collaborative communications between a plurality of platform users 300 and external individuals. Collaboration platform 340 is preferably implemented via one or more Internet-accessible server computers. Platform users maintain one or more email accounts hosted by one or more of mail servers 330. Collaboration platform 340 includes an email synchronization subsystem that communicates with mail servers 330, acting as a mail client using mail client communication protocols such as IMAP, SMTP or MAPI. Thus, users 300 may use collaboration platform 340 in conjunction with pre-existing email accounts hosted by providers such as Gmail, Yahoo!, Microsoft 365, and publicly or privately hosted Microsoft Exchange servers. Furthermore, email activities undertaken within collaboration platform 340 are synchronized back to mail servers 330, so that alternative mail clients that may be available to the user (e.g. Outlook, smartphone or tablet computer mail apps, host-provided webmail) remain up to date with email account activity undertaken within collaboration platform 340 and collaboration client 315.

Users 300 of the communications system illustrated in FIG. 3 access the system via one or more computing devices, such as user device 310. Users 300 may use one or more types of devices, including but not limited to desktop computers, laptop computers, tablet computers, mobile phones, wearable computers, and computing devices integrated into automobiles.

User device 310 includes collaboration client 315. Collaboration client 315 enables interaction between a user of device 310 and collaboration platform 340 via data connection 352 and data network 320, which may include the Internet. For example, in some use cases of the embodiment of FIG. 3, collaboration client 315 could be implemented as a web application executed within web browser software running on user device 310. In other use cases, collaboration client 315 can be implemented via a standalone software application running on client device 310.

A given user may use multiple instances of user devices 300 to access collaboration platform 340, such as a home desktop computer, a laptop computer, a mobile phone and a tablet computer. Preferably, user input to collaboration client 315 is streamed back to collaboration platform 340 via network connection 352 substantially in real time, so that the state of collaboration client 315 remains substantially synchronized across multiple user devices. In such an embodiment, e.g., a user can begin an email in a Compose Mail interface on their desktop computer at their office, leave for the day, and complete the email via a tablet computer during their commute home.

FIG. 4 is a schematic block diagram of a database implementation associated with an embodiment of the collaborative email system described herein. In the embodiment of FIG. 3, the database implementation of FIG. 4 may be implemented within collaboration platform 340. Unified database 400 contains a combination of shared and private record types. Database 400 contains records associated with multiple users of collaboration platform 340, and each such record may be a shared record or a private record. Private records contain information that is made available only to a single user of platform 340. A shared record contains information that is accessible to multiple users of collaboration platform 340. For example, a shared contact may contain name, phone number, email and address information for a customer, which can be viewed and updated by any member of a company or sales team using collaboration platform 340.

Shared records may be made available to configurable subsets of users of collaboration platform 340. For example, the scope of sharing may include all users associated with a particular company, all users designated as belonging to a criteria such as a department, a user-defined set of users working on a particular project, or other sets of users satisfying various combinations of system-generated and/or user-defined criteria.

As an illustrative example of how the database structure embodiment of FIG. 4 may be used, email record 410 is associated with an email account for User A. Email record 410 is pulled from one of mail servers 330 which is identified within platform 340 as hosting the email account for User A. Email record 412 is associated with an email account for User B, and is pulled from one of mail servers 330 which is identified within platform 340 as hosting the email account of User B. Email records 410 and 412 may each specify a recipient associated with contact record 420. Contact record 420 is a “shared contact”, meaning that information stored within the record is accessible to multiple users of collaboration platform 340, including User A and User B.

In some embodiments of the system, maintenance of contact record 420 as a shared contact enables collaborative activities between User A and User B. For example, User A may be able to access contact record 420 and review all email communications involved the individual that is the subject of contact record 420, including both emails 410 and 420, thereby obtaining a complete picture of communications with that contact. In accordance with another aspect of the embodiment, either User A or User B can update the contents of contact record 420. Therefore, if the email associated with email record 410 communicated a new mobile phone number to User A for the contact associated with contact record 420, User A could access and update contact record 420 to include that new mobile phone number. The updated contents of contact record 420 would then also be available to User B, thereby ensuring that both users have access to the most current information associated with the contact of record 420.

Embodiments of the system architecture reflected in FIGS. 3 and 4, in which the system includes email records for multiple users and shared contact records fully integrated within a common database, may enable benefits relative to prior art architectures such as that of FIGS. 1 and 2. For example, by integrating the mail client with a shared contact database it may be possible to obtain faster association between records of different types inasmuch as indirect linking between separate databases can be avoided. Maintaining an integrated database may reduce overhead necessary to forward information between, e.g., mail server 130 and CRM server 140 in the embodiment of FIG. 1. Maintaining an integrated email/shared contact database may also reduce or eliminate database synchronization problems, such as might occur if one user sends and email to or receives an email from a particular contact, and another user queries CRM server 140 for email activity with that particular contact before mail client 105 or mailer server 130 has notified CRM Server 140 that the email communication occurred.

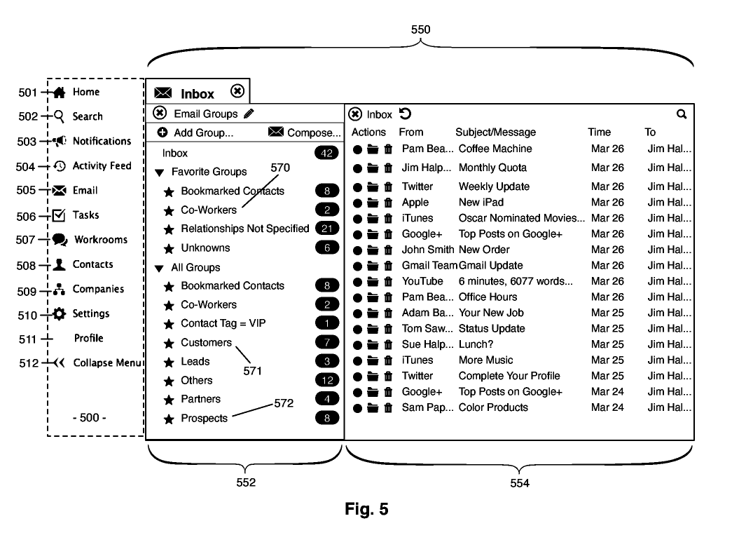

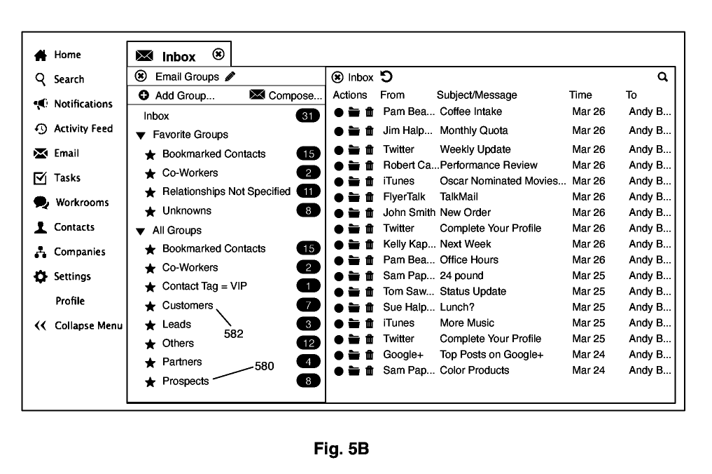

In an exemplary embodiment, collaboration client 315 (FIG. 3) serves to render a user interface on user device 310 that facilitates interaction between the user of device 310 and collaboration platform 340. Such a user interface may be rendered, for example, via a web application implemented on a web browser running on device 310. FIG. 5 illustrates one exemplary user interface that may be rendered via interaction of collaboration client 315 with platform 340.

Collaboration client 340 is configured to enable multiple types of communications and may be commonly employed in the context of busy office workers switching back and forth between multiple ongoing activities and communications. In many such applications it may be important to have a user interface that facilitates these types of multitasking communications, while also being intuitive and easy to use for the user. FIG. 5 et seq. illustrate embodiments of a user interface that may be implemented to achieve these goals.

The user interface of FIG. 5 includes a navigation menu 500 which enables a user to select from amongst a plurality of functional areas implemented by collaboration platform 340 and made available to the user. Region 550 provides information pertinent to the functional area most recently selected within menu 500. Functional areas provided by the embodiment of FIG. 5 include: Home button 501, Search button 502 (enabling system-wide search), Notifications button 503 (enabling a list view of notifications to the user within the system), Activity Feed button 504 (user-organizable list of activity within the system), Email button 505 (access to email), Tasks button 506 (access to task list), Workrooms button 507 (Internet-accessible collaboration spaces amongst internal and external users), Contacts button 508 (shared contacts management functionality), Companies button 509 (activities and information organized by company), Settings button 510 (configuration of system settings), Profile button 511 (personal user profile) and Collapse Menu button 512 (reduce width of navigation menu bar by removing text portion to make more screen space available for activity region 550).

One challenge in user interface design is to enable users to work within complex systems, while still providing intuitive visual cues as to where in the system the user is working. To that end, the illustrated user interface operates in accordance with a “sliding panes” methodology. FIG. 5 illustrates a default entry display for email functionality. The width of the activity region 550 is generally divided between a navigation pane 552, and a message list pane 554. Navigation pane 552 enables a user to access a desired subset of their email messages. Subsets may be determined by systemic criteria (e.g. email accounts; or system-generated folders within email accounts such as inbox, sent items, and deleted items) or by user-generated criteria. User-generated subsets may be organized manually (e.g. via creation of folders within an email account and foldering of emails within them) or via automated means.

Amongst the automated means for email grouping, collaboration platform 340 and its interaction with collaboration client 315 provides users with dynamically-populated email groups based on categorization of shared contacts within the database. Where users receive significant volumes of email, it may be desirable to dynamically group emails based on the relationship of the sender to the company. This would enable users to easily separate emails into groups that may warrant different priority levels, e.g., communications from contacts with a Customer relationship status can be separated from, and perhaps prioritized over, communications from contacts having relationship status as Vendor or Newsletter.

For example, in FIG. 5, selection of Group 570 presents the user with a list of messages in the user's inboxes that are addressed to contacts categorized by the user as having a Relationship Status of Co-Worker. Selection of Group 571 presents the user with a list of messages in the user's inboxes that are addressed to contacts categorized by the user as having a Relationship Status of Customer. Similarly, contacts can be assigned to a plurality of relationship statuses, such as Prospect, Lead, Partner, Vendor, Other, or user-defined relationships.

In the prior art, some users have configured email “Rules” that might, for example, automatically place emails into different folders based on the identity of the sender or keywords within the email. However, such systems require continuous updating and maintenance of the categorization rules as relationships with the contacts change.

By contrast, the “smart inbox” email groups provided by embodiments of the collaboration platform described herein automatically categorize messages based on information within a contact record in a shared contacts database. Therefore, as users of the collaboration platform update the Relationship status of a contact, emails with that contact are automatically recategorized into the appropriate Smart Inbox for all users of the system having access to the updated contact record. For example, if an employee of a sales organization closes a sale, the employee would update the relationship status of the buyer's contact record from “Prospect” to “Customer”, at which point email communications with that contact would automatically move from Prospects email group 572 to Customers email group 571. This automatic recategorization would take place for all users having access to the shared contact. For example, FIG. 5B depicts an email view for a different user of collaboration platform 340, in which emails from the above-described contact would automatically move from Prospects email group 580 to Customers email group 582.

By default, message list pane 554 displays an aggregated list of email messages within the user's Inboxes. If the user selects another group within navigation pane 552, the display within message list pane 554 is updated to reflect the messages corresponding to the selected group.

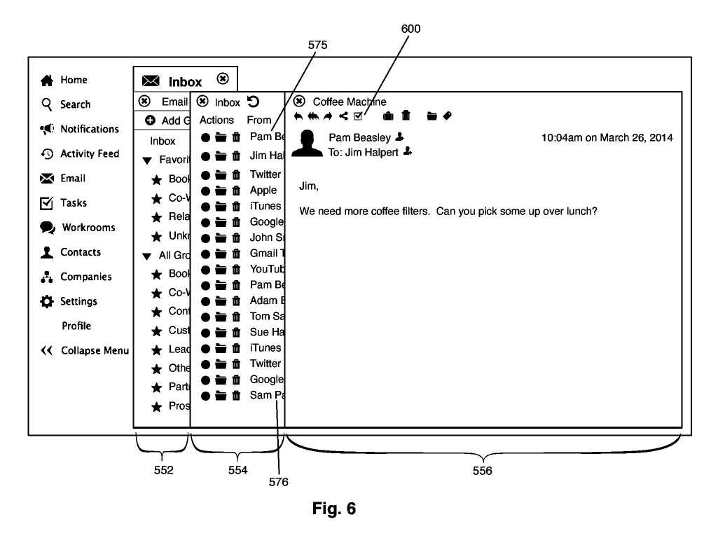

Upon selection of a message within pane 554, the “sliding panes” user interface is activated. The end result is illustrated in FIG. 6. Pane 554 begins sliding left to overlap a portion of pane 552, while new pane 556 (in this case, a Read Message pane) simultaneously slides in from the right to overlap a portion of pane 554. Several aspects of this interface provide an intuitive and functional implementation for the user. The sliding animation provides the user with a visual cue as to the context of the information on the various panes, reflecting the action sequence undertaken to reach the current state of the user interface and user context for the current operation.

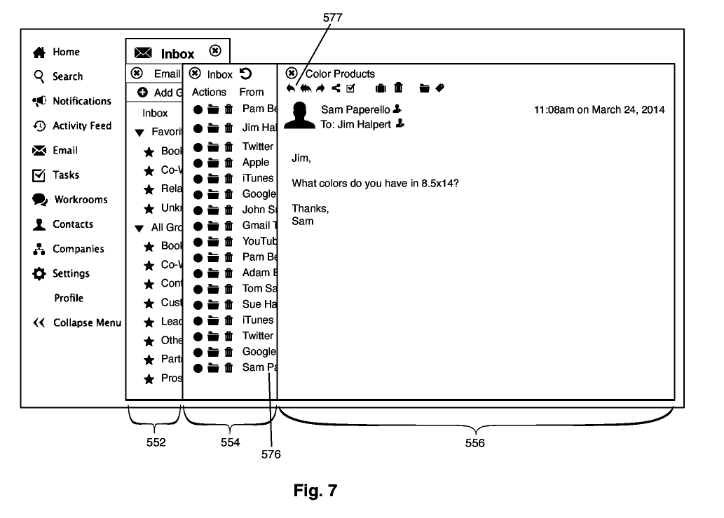

Preferably, the interface also provides rapid navigational functionality by maintaining the underlying panes as active elements. For example, the message displayed in pane 556 corresponds to selection of Inbox message 575. However, message 576 can be selected within partially-overlapped pane 554 in order to directly display that different message within pane 556, the result of which selection is illustrated in FIG. 7. To the extent a list displayed in an active sub-pane such as 552 or 554 exceeds the vertical length available on the display, the lists within active sub-panes can be scrolled as well, via user actuation of a scrolling function while hovering over the desired active sub-pane. Therefore, the sliding pane interface with active sub-panes also provides rapid, direct access to information as multiple levels of the user interface.

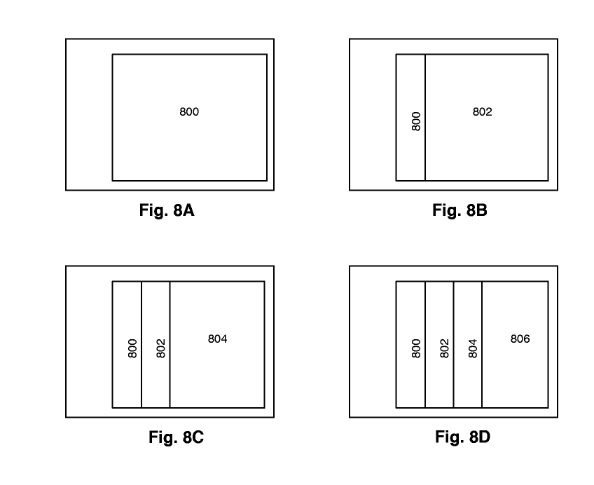

Embodiments of the sliding panes user interface can be readily adapted to a variety of display sizes and form factors, while maintaining consistency of user experience. For example, the maximum number of panes displayed may be controlled based on the display size and form factor. FIG. 8 illustrates a progression of four sliding panes that may be suitable for a desktop computer display. FIG. 8A illustrates a first information pane 800. Selection of an item within pane 800 introduces second pane 802 sliding in from the right to overlap a portion of pane 800. Selection of an item within second pane 802 introduces third pane 804, also sliding in from the right to overlap a portion of pane 802. Selection of an item within third pane 804 introduces fourth pane 806, also sliding in from the right to overlap a portion of pane 804.

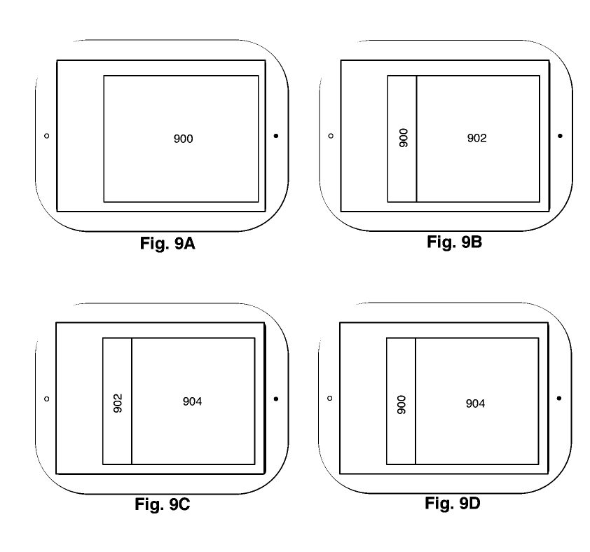

For a smaller display, such as a tablet computer, it may be desirable in some embodiments to reduce the maximum displayed depth of panes so that sufficient screen space is maintained for the top pane, while still enabling a sufficient amount of space displayed in underlying panes to facilitate active navigation within the underlying pane. FIG. 9 illustrates such an embodiment in the context of a tablet computer. FIG. 9A illustrates a tablet computer displaying first user interface pane 900. Selection of an item within pane 900 results in the addition of overlying pane 902 (FIG. 9B). In the tablet computer embodiment of FIG. 9, the number of displayed panes is limited to two. Therefore, selection of a further item within pane 902 can result in a variety of outcomes. In some embodiments, such as that of FIG. 9C, it may be desirable to continue stacking panes, with the bottom-most panes having contents completely or substantially overlapped by the two top-most panes (e.g. panes 902 and 904). In other embodiments, such as that of FIG. 9D, it may be desirable to maintain a fixed pane 900 as an anchor navigation pane; in which case interim pane 902 is completely or largely obscured beneath top-most pane 904. For a mobile phone display, it may be desirable to utilize a single level of active panes in the user interface, with all panes beneath the top-most pane being substantially or completely obscured. In any case, the adoption of a common sliding panes user interface paradigm for PC, tablet and mobile computing environments provides a consistent user experience across platforms and facilitates intuitive understanding of system operation.

The overlap level of panes can also be dynamically adjusted based on display size. In some embodiments, a system designer may wish to specify a predetermined percentage of each pane that remains visible once an additional pane is brought on above it. In other embodiments, as display size is reduced, a designer may wish to prioritize the availability of space within the top-most active pane by reducing the proportion of the display allocated to underlying panes. In yet other embodiments, as display size is reduced, a designer may wish to ensure that a sufficient amount of an underlying pane remains visible for a user to comprehend the contents of the underlying pane and navigation directly to different objects on the underlying pane.

Embodiments of the sliding panes user interface can be readily adapted to a variety of functional areas. In the context of email, a typical interaction might begin with an email navigation pane and message list, per FIG. 5. Selection of a message may bring up a Read Email pane displaying the contents of the selected message. Selection of the email sender's name may then bring up that individual's Contact record, such that the user can review information about, e.g., prior interactions with the sender.

Another potential use case for the sliding panes interface described above is in the context of a Contacts management function. E.g., selection of Contacts icon 508 within navigation menu 500 may bring up a Contacts Groups pane and a Contacts List pane. Selection of a Contact within the contacts list pane may then bring up a Contact Record pane overlapping the contacts list and contacts groups panes. These and other interactions can be achieved through the described user interface to provide varied and complex functionality in a way that is easy for the user to navigate and understand.

While the above figures are described as implementing a “sliding panes” interface, and the preferred interaction between successive information areas includes a sliding animation, it is understood and expressly contemplated that other embodiments of the above-described user interface functionality could be implemented with different animations and orientations of the successive panes (sliding from another direction, fading in and out, etc.), or with no animation at all.

The collaboration platform embodiments described herein can be effectively used by individuals during the course of daily work and/or communications. However, in that context, individuals frequently switch between tasks. For example, during the course of drafting an email, a user may receive a telephone call that requires the recall of information from elsewhere in the collaboration platform, such as a contact record or another email. Numerous other scenarios can arise as well, in which a user switches tasks while actively editing information.

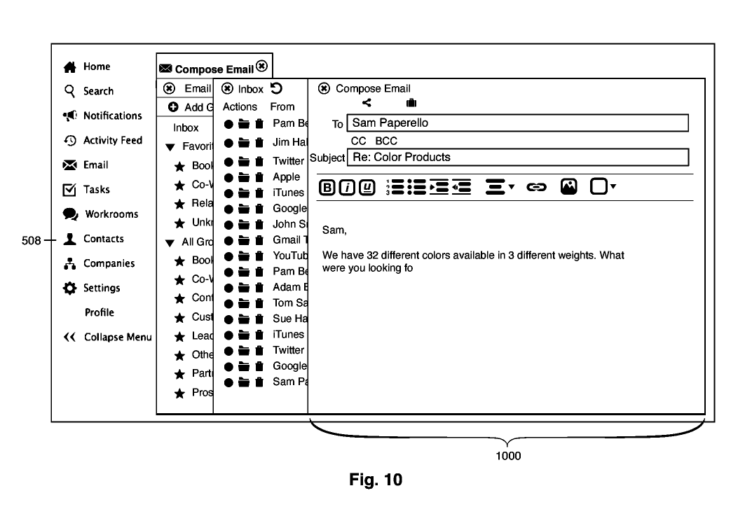

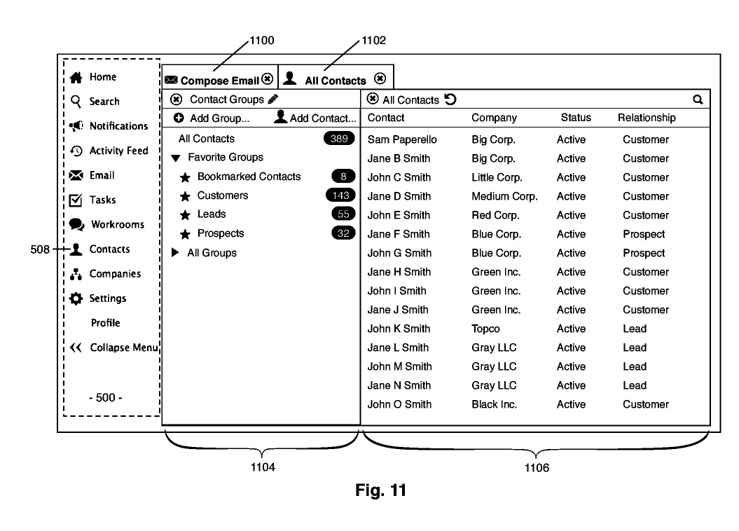

To address such scenarios, collaboration client 315 is designed to facilitate versatile task switching while preventing users from inadvertently losing uncommitted form data. FIGS. 10 and 11 illustrate this functionality. FIG. 10 illustrates the result of the user having selected email 576 within the email list pane of FIG. 7, and then having selected “reply” button 577. Compose Email pane 1000 is displayed, in which the user has begun drafting a reply but has not yet hit Send. The user may then have a need to access information elsewhere in the system, such as a contact record. In that case, the user may press Contacts button 508 in the lefthand navigation menu.

Given this scenario, with the user having navigated away to another part of the system with uncommitted form data in pane 1000, many prior art systems would interrupt the user with a prompt confirming the intended action. For example, the prompt might indicate to the user that they are navigating away and that data might be lost, with options for the user to Cancel the navigation action, Proceed with the navigation action, and perhaps in some systems, Save A Draft of the uncommitted form data.

By contrast, the platform of FIG. 10 responds to navigation away with uncommitted form data by automatically popping up a new user interface element, such as a tab or navigation menu item. For example, if a user selects Contacts menu item 508 in the context of FIG. 10 with uncommitted changes to a Compose Email pane, collaboration client 315 responds by rendering the tabbed user interface illustrated in FIG. 11. Specifically, the Compose Email interface of FIG. 10 is maintained in a lower-level tab 1100, while a new upper-level All Contacts tab 1102 is rendered with contacts navigation pane 1104 and contacts list pane 1106. Tab 1102 presents an additional and independent user interface enabling the user to navigate to additional information and perform additional interactions with the collaboration platform, preferably implementing a separate instance of the sliding panes interface described hereinabove, independently of the actions performed within lower level tab 1100.

By automatically generating a new tab in response to navigation attempts when uncommitted form data is present in the user interface of an active tab, the collaboration platform enables fast and seamless access to information without interrupting the user or risking loss of user-entered information. This paradigm can be extended; e.g. if a contact is selected and edited within the user interface of tab 1102, and navigation is attempted to another component of the system without saving edits to the contact record at issue, yet another tab can be automatically generated. The user can then quickly and easily navigate between tabs, editing and/or extracting information from multiple locations within the collaboration platform simultaneously.

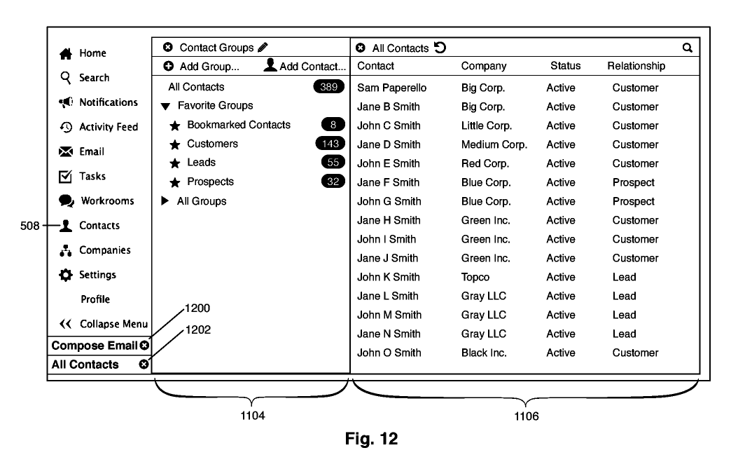

While the embodiment of FIGS. 10-11 illustrate a tabbed interface rendered with conventional user interface indicia (i.e. generally rectangular tabs appearing above the active work area), it is understood and expressly contemplated that other analogs for separate work areas can be readily employed in connection with the concepts described herein. For example, each work area could be represented by a user interface element in the left side navigation menu 500, rather than a top side tab. FIG. 12 illustrates one such embodiment, in which “side tab” navigation element 1200 is rendered in lieu of “top tab” 1100 from FIG. 11, and “side tab” navigation element 1202 is rendered in lieu of “top tab” 1102 from FIG. 11. The arrangement of FIG. 12, with side navigational elements, may be particularly desirable for user interfaces rendered on display screens with a wide aspect ratio, such as a smartphone or wide screen laptop computer.

Embodiments of the integrated collaborative communications system described hereinabove can also enable innovative task management functionality. Many users utilize their email inboxes as de facto task lists. If an email comes in that requires an action on the part of the user that cannot be promptly accomplished upon first reading the email, many users allow the email to remain in their inboxes as a “reminder” to complete the associated task at a later time. With this working method, some users even send emails to themselves as reminders to accomplish a task at a later time. However, this method of working can quickly lead to overloaded email inboxes. It also does not easily enable a user to prioritize, categorize, organize or delegate tasks. Others have addressed task management with solutions such as Microsoft Outlook's “Tasks” feature, the Basecamp project management platform by 37Signals, or various smartphone task apps.

The collaboration platform described hereinabove facilitates task management via deep integration with the shared contacts database and other communications channels, such as collaborative email and workrooms. Tasks can be generated directly from other objects, such as emails, while automatically extracting content from the source object and relating the task to other objects in the system, such as the source object, workrooms, sender and recipients.

For example, consider the email illustrated in the user interface of FIG. 6. The content of the email is requesting that the recipient purchase an item. The recipient can then select “check box” icon 600 in order to generate a task associated with that request, thereafter enabling the user to remove the item from their inbox without worrying about forgetting the task.

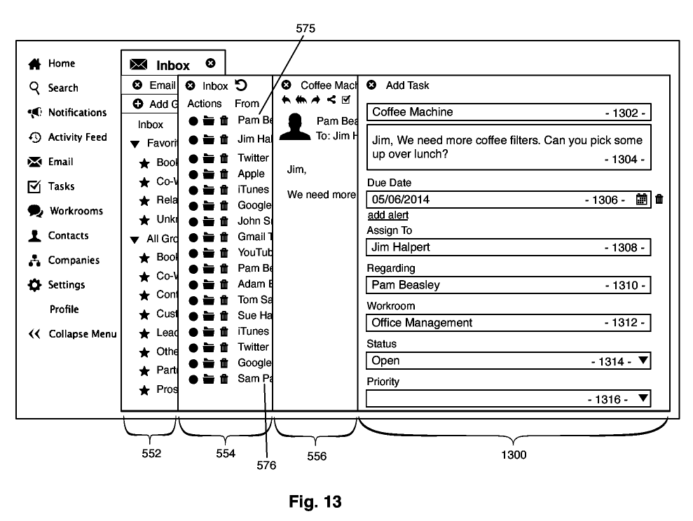

FIG. 13 illustrates a user interface generated at collaboration client 315 in response to actuation of icon 600. Add Task pane 1300 is generated on user device 310 via collaboration client 315, preferably via the sliding panes user interface described hereinabove. The embodiment of FIG. 13 leverages unified-database integration between related collaboration functions, such as email, contacts and workrooms, in order to automate aspects of the task management function. For example, Add Task pane 1300 includes several data fields, including but not limited to Task Title 1302, Task Description 1304, Due Date 1306, Assignee(s) 1308, Regarding 1310, Workroom 1312, Status 1314, Priority 1316, and Type (not shown). Task Title 1302 is prepopulated with the subject line of email 575, from which the task was generated. Task Description 1304 is prepopulated with text content from email 575. Assignee 1308 is prepopulated with the currently logged-in user. Regarding field 1310 may be prepopulated with the recipient of email 575. The integration of task management functionality within the collaboration platform enables fields 1302, 1304, 1308 and 1310 to be pre-populated with relevant information that often will not require any additional input by the user, thereby saving time and increasing user satisfaction.

Due Date field 1306 can be populated by the user to specify a date by which the task should be completed. Workroom field 1312 can be used to associate the new task with a collaborative Workroom, also implemented by the system. Status field 1314 can be used to track the current status of a task (e.g. Open, On Hold, Maybe Someday, In Progress, Awaiting Review, Complete, Cancelled). Priority field 1316 can be used to categorize the priority of this task relative to others (e.g. Low, Medium, or High). A Type field can be used to classify the nature of the task, such as Call, Email or Other, which may be useful if a user desires to, e.g., spend a period of time making phone calls during regular business hours.

Completion and submission of information within Add Task pane 1300 operates to generate a Task record within the unified collaboration platform database structure, such as Task record 430 in FIG. 4. The above-described integration of task management within collaboration platform enables task data to be utilized in new and powerful ways. For example, when looking up a customer's contact record within a shared contact database, information returned may include tasks assigned to coworkers in which the customer contact record is referenced in Regarding field 1310. As another example, if a task relates to a collaborative group project for which a Workroom has been set up and that workroom is specified in Workroom field 1312, participants of that workroom can see that a related task has been generated and assigned. As another example, a manager can lookup a subordinate employee's contact record, identify tasks assigned to that employee, and if the employee is overloaded, change the value in Assignee field 1308 to reassign the task to another contact.

The above-described integrated collaboration platform also provides opportunities for beneficial management of user files, such as spreadsheets, graphic images, word processing documents, PDF documents and the like. User files can be stored as objects within unified database 400, such as File 440. The implementation of a unified database enables embodiments providing efficient and collaborative storage and retrieval of files. For example, when collaboration platform 340 retrieves an email containing an attached file from mail server 330, collaboration platform 340 acts to separate the attached file from the email and store the email and attachment as separate objects within database 400, such as Email 442 and File 440. If the same email was addressed to two users of collaboration platform 340 (e.g. User A and User C in FIG. 4), the email portion may be stored as separate records 442 and 444, but the attachment need only be stored once as File object 440, thereby enabling single instance storage of email attachments.

Another beneficial file management capability enabled by embodiments of the integrated collaboration platform is the ability to relate a single file object with many different contexts within the collaboration platform to which the file is relevant. For example, file object 440 relates to email records 442 and 444, in two different user email accounts. If database 400 includes a Contact record associated with the email sender, such as Contact Record 420, then file object 440 also relates within the database to Contact Record 420, such that emails 442 and 444, along with file 440, would all be displayed by, or made accessible within, collaboration client 315 in response to a user request to view contact record 420. Moreover, if the file contained in file object 440 is relevant to communications taking place within a collaboration platform workroom, a workroom participant can share the file to the workroom from any view in which the file is accessible, such as while viewing email 442 on collaboration client 315, or while viewing contact record 420 on collaboration client 315. Once shared to the Workroom, users can download, view, comment on or further share the file. All of this functionality can be implemented via non-duplicative/single-instance storage of file 440, within minimal latency and without potential problems maintaining synchronization between disparate systems.

Systems and methods implemented as described herein can be utilized in some embodiments to provide electronic collaboration mechanisms having significantly greater functionality than alternative solutions, particularly less integrated solutions. Specifically, as described above, it may be particularly beneficial to implement one or more of a native email client and shared collaboration management; a native email client with shared and collaborative task management; a native email client with shared and collaborative contact management; a native email client with shared and collaborative file management; or most preferably, all of the above.

In some collaboration platform embodiments, it may be desirable to implement a chat communication mechanism, in addition to or instead of email. Chat services are commonly implemented using the Extensible Messaging and Presence Protocol (XMPP). Communications via such chat platforms are typically characterized by random, asynchronous communications amongst two or more users. Chat communications are typically mixed within a stream of communications, and not systematically organized or separated by topic.

Chat communications may be highly effective for rapid, interactive communications between individuals. However, there are numerous circumstances in which chat communications may be inefficient, inhibit information synthesis, or complicate information recall. For example, teams of users working together may intermingle communications regarding a variety of topics. Another use case that may be challenging for chat environments is when a topic is discussed over an extended period of time, such that prior communications regarding the same topic are intermingled with unrelated communications and difficult to find or put in context.

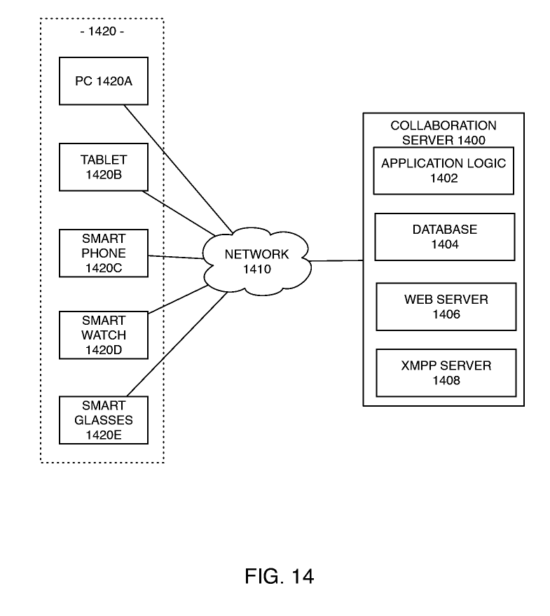

FIG. 14 illustrates a schematic block diagram of a computing environment in which embodiments described herein can be implemented. User computing devices 1420, such as personal computer 1420A, tablet computer 1420B, smart phone 1420C, smart watch 1420D, or smart glasses 1420E, operate to execute software, process data and present graphical displays to users thereof. Computing devices 1420 are preferably interconnected with network 1410, which may include the Internet, for communication with one or more servers 1400. That said, some embodiments described herein can also be beneficially implemented on standalone computing devices, such as devices 1420, whether connected to a digital network or not. While FIG. 14 illustrates five exemplary user computing devices, it is contemplated and understood that implementations may include one such device, or large numbers of user devices communicating with one another. In some circumstances, a given individual may utilize multiple user devices in connection with the illustrated embodiments.

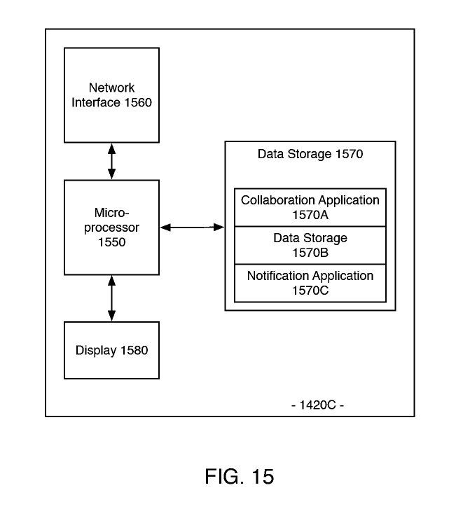

FIG. 15 is a schematic block diagram of an exemplary user device 1420A. User device 1420A includes microprocessor 1550. Microprocessor 1550 is configured to transfer data back and forth with data storage 1570, which may include digital memory. Data storage 1570 contains, inter alia, collaboration app 1570A, data store 1570B, and notification application 1570C. Network interface 1560 enables data communications with external networks, and may include common communication mechanisms including a cellular modem, Bluetooth interface and/or wireless Ethernet interface. Display 1580 enables user interaction with device 1420A. When executed by, inter alia, microprocessor 1550, collaboration application 1570A enables communications between user device 1420A and server 1400. Notification application 1570C enables conveyance of push notifications from server 1400 to user device 1420A, even when collaboration app 1570A is not being executed by microprocessor 1550.

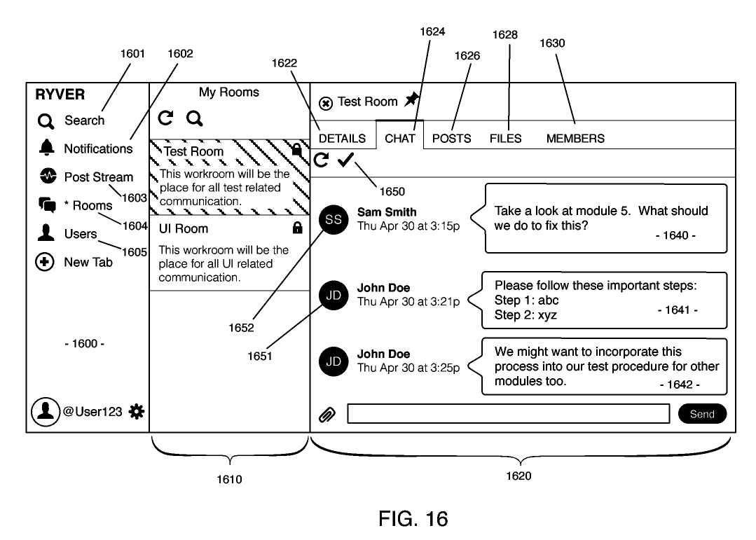

FIG. 16 illustrates an exemplary user interface associated with a collaboration platform embodiment utilizing chat communication techniques. The user interface of FIG. 16 is rendered on a display by personal computer 1420A, such as via operation of a web browser or locally-installed software application communicating with server 1400. However, in other embodiments, it is contemplated and understood that functionally analogous displays or different user interface techniques may be rendered by other types of user devices to achieve objectives described herein.

Similarly to the embodiment of FIG. 5, the user interface of FIG. 16 includes a navigation menu region 1600 which enables a user to select from amongst a plurality of functional areas implemented by collaboration server 1400 and made available to the user. Region 1610 provides information pertinent to the functional area most recently selected within menu 1600. Functional areas provided by the embodiment of FIG. 16 include: Search button 1601 (enabling system-wide search), Notifications button 1602 (enabling a list view of notifications to the user within the system), Post Stream button 1603, Rooms button 1604 (Internet-accessible collaboration spaces amongst internal and external users), and Users button 1605.

In FIG. 16, Rooms button 1604 has been selected. Region 1610 displays a listing of Rooms to which the user has been provided with access. In some embodiments, Rooms are persistent workspaces configured for use by definable teams of users, and may include a persistent group chat function, file storage, content item posting, and the like. In the embodiment of FIG. 16, region 1620 displays content associated with the Room selected in region 1610. Header buttons 1622, 1624, 1626, 1628 and 1630 display various types of content within the selected Room, including Details 1622 (information regarding the Room configuration), Chat 1624 (chronological unstructured messaging), Posts 1626 (topic-based content contributions with associated discussion), Files 1628 (shared files), and Member 1630 (specifying users having access to the selected Room).

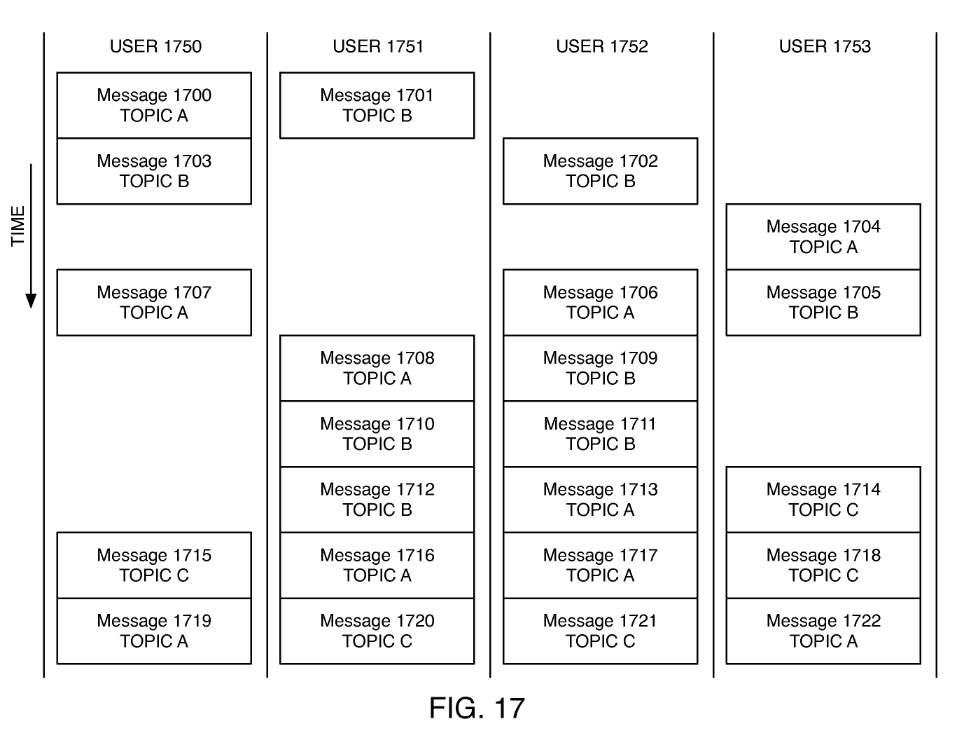

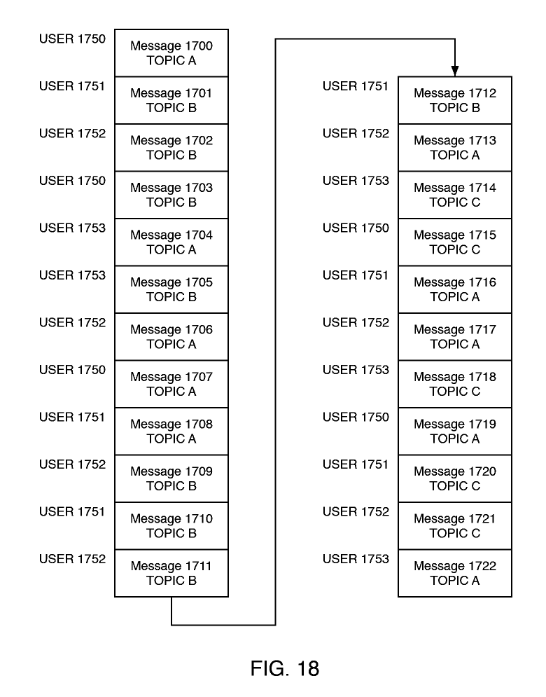

Chat 1624 and Posts 1626 provide access to two different mechanisms for content contribution. Chat 1624 displays a chat message stream in region 1620, implemented using XMPP server 1408. The chat stream presentation typically organizes content chronologically, and contains visual indicia of messages submitted by members of the Room with which the chat stream is associated and the associated members; e.g. avatars 1651 and 1652, and messages 1640, 1641 and 1642. Chat tab 1624 facilitates informal, near real-time communications amongst individuals. However, over time, the chat stream may intermingle multiple topics of discussion pertinent to various combinations of members in the Room, such that it may be challenging for individuals to obtain a comprehensive view of communications concerning a given topic. Users may frequently scroll up and down within a chat stream, trying to piece together the meaning and context of nonadjacent user messages. For example, FIG. 17 is a simple exemplary schematic block diagram of a chat conversation amongst four Room members (users 1750, 1751, 1752 and 1753) concerning three topics (TOPIC A, TOPIC B and TOPIC C). FIG. 18 illustrates the conversation of FIG. 17, unpacked into a chronological chat stream. A user coming into the chat stream of FIG. 18 may have significant challenges piecing together communications concerning any one of TOPICS A, B or C from amongst the chronological freeform chat stream.

By contrast, Post function 1626 enables collaborative communication organized by topics or content item. An initial content contributor generates a Post content item. Other users can then contribute comments and other content, that is associated with the original Post content item. Content presentation within Post section 1626 is typically grouped by Post, before being presented chronologically (whether by Post date or date of last comment). By aggregating communications pertinent to a given content item together in a content item group during presentation, Posts function 1626 may effectively facilitate topic-oriented communications over an extended period of time.

Separate Posts and Chat functions provide two different mechanisms for team communications, which can preferably be utilized by team members depending upon which mechanism is optimal for a particular type of communication. However, in actual use, circumstances may arise in which informal team communications begin as chat messaging, but evolve into a topic-oriented discussion that will be pertinent over an extended period of time. In order to facilitate optimal organization of collaboration platform information, the collaboration platform implemented by server 1400 enables seamless interaction between chat-based communications and post-based communications. To that end, server 1400 implements a Promote To Post feature, via which users can easily generate a Post from one or more chat messages.

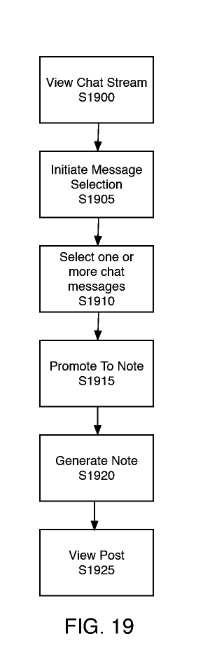

FIG. 19 illustrates a process for generating a Post from one or more chat messages. For example, in step S1900, a user selects Chat user interface element 1624 to open within region 1620 a chat stream view in which messages contributed by members of the selected Room are arranged chronologically, including messages 1640, 1641 and 1642. In step S1905, the user selects check mark icon 1650 to initiate a multiselect process in which the user can select one or more chat messages, potentially including nonadjacent messages selected by scrolling through the chat stream in region 1620.

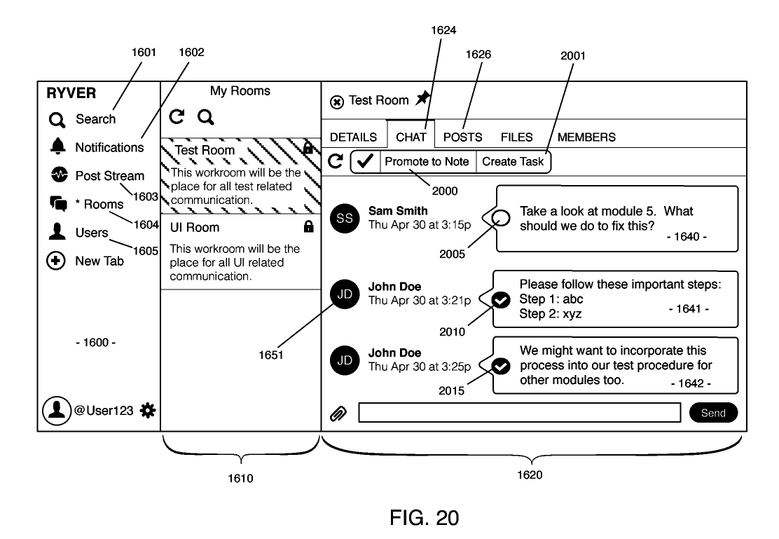

Selection of icon 1650 causes the presentation of selection handle user interface elements associated with each chat message in the chat window, including selection handles 2005, 2010 and 2015 on chat messages 1640, 1641 and 1642, respectively (FIG. 20). Promote To Note button 2000 is also presented as an element within the user interface, in response to selection of icon 1650. In step S1910, the user actuates one or more selection handles, potentially including selection of non-adjacent messages selected from amongst an extended chat stream in which contributions associated with varying topics, content and contributors are intermingled. In the example of FIG. 20, selection handles 2010 and 2015 have been actuated to select messages 1641 and 1642.

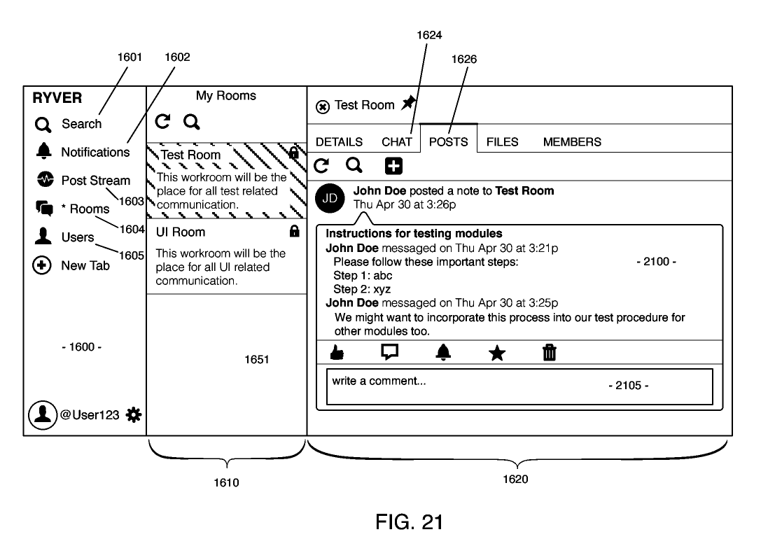

The user may then initiate the generation of a Post content item by server 1400, based on the selected chat messages, by selecting Promote To Note user interface element 2000 displayed on user device 1420 (step S1915). In step S1920, server 1400 implements application logic 1402 to generate and store a post in database 1404, automatically incorporating content from chat messages 1641 and 1642. The post can subsequently be presented to a user viewing content within the Posts collaboration mechanism associated with the room from which chat messages 1641 and 1642 were selected (step S1925). FIG. 21 illustrates a user interface rendered upon selection of Posts tab 1626, following step S1920. Note 2100 was generated in step S1920, and is displayed in region 1620 when Posts tab 1626 is selected.

Within Posts tab 1626, further communications and messaging amongst room members can be transacted, over a potentially extended period of time, while remaining associated with, and preferably displayed as a group with, the originating content item. In particular, users can enter additional content in comment prompt 2105. That content is then stored within database 1404 and associated with post 2100, such that it can subsequently be displayed, or made available for display, proximate to post 2100, as a content group.

Accordingly, the embodiment of FIGS. 14-21 provides a seamless mechanism for collaboration platform users to automatically generate topic-oriented post content items via selection of one or more chat messages that are typically related to a common topic but potentially widely distributed across a diverse chat stream. The embodiment avoids having to manually copy-and-paste multiple chat items into a post-based content item, likely implemented on an entirely different information system. Instead, some embodiments enable generation of such Post content items with an initiating user interface element selection, selection of one or more chat messages, and a selection of a single user interface element to automatically generate the Post. Such an embodiment not only saves users significant time and effort, but also encourages users to move communications into the optimal collaboration environment (e.g. Posts versus Chat) by lowering the barrier to transition between them.

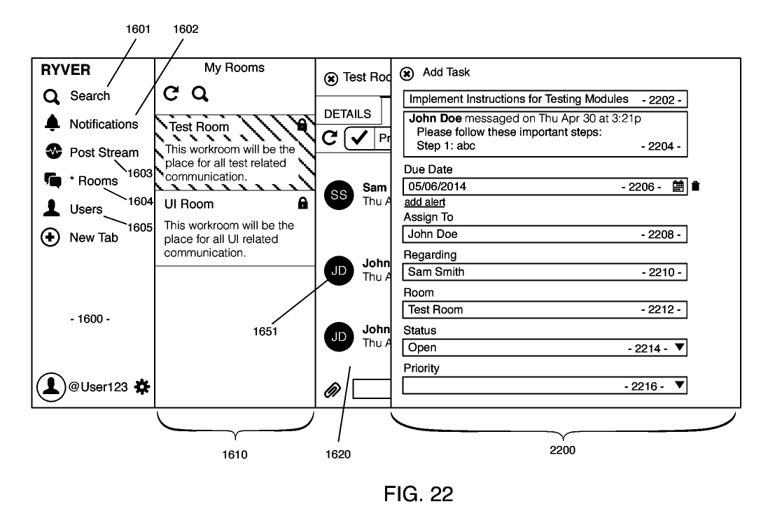

Collaboration server 1400 may also be effectively utilized to implement task management functionality. Creation of a task from an email communication within a collaboration platform embodiment is described above in connection with FIG. 13. An analogous operation can be implemented with other forms of user messaging, including the chat-based collaboration platform implemented by server 1400. Upon actuation of the chat message multi-select icon 1650 in FIG. 16, and upon selection of one or more chat messages via the user interface of FIG. 20, Create Task icon 2001 can be selected to initiate the creation of a Task within a task management platform, incorporating the content of selected chat messages 1641 and 1642. Subsequently, as illustrated in FIG. 22, Add Task sliding pane 2200 is presented, sliding in from screen right and partially overlying pane 1620, analogously to pane 1300 in FIG. 13. The content of the selected chat messages automatically populated into task detail field 2204. Task fields 2202, 2206, 2208, 2210, 2212, 2214 and 2216 are analogous to fields 1302, 1306, 1308, 1310, 1312, 1314 and 1316, respectively. In some embodiments, the task fields of FIG. 22 can be prepopulated with information associated with the task creation event. For example, task title 2202 may optionally be prepopulated with the first sentence of the first selected chat item. Task description 2204 is preferably prepopulated with the content of selected chat messages. Assignee 2208 may be prepopulated with the currently logged-in user who initiated the task creation. Regarding field 2210 may be prepopulated with the authors of chat messages selected during creation of the task.

While the chat-based collaboration platform described above can be effectively implemented to facilitate group collaboration, in some circumstances it may also be desirable to enable one-one-one communications amongst members of a group, with minimal user-system interaction and minimal context switching cost. To that end, collaboration server 1400 utilizes the sliding panes user interface described hereinabove to implement one-click transition to private messaging, without leaving the group collaboration platform context.

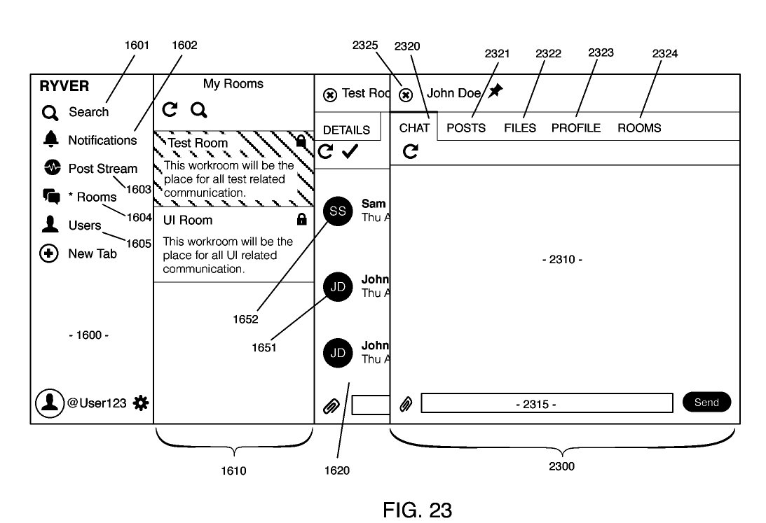

In the context of the group chat pane of FIG. 16, a user can select a user interface element associated with another user whose chat message is displayed in region 1620, such as avatars 1651 and 1652. Selection of user 1651 initiates user-specific sliding pane 2300, partially overlaying region 1620, as illustrated in FIG. 23. User pane 2300 includes information associated with user 1651, and defaults to presentation of chat tab 2320 to facilitate seamless continuation of dialog via one-on-one messaging. Chat window 2310 shows prior one-on-one communications between the current user and user 1651. Chat message prompt 2315 enables a user to immediately enter a message for one-on-one communication to user 1651. User pane 2300 also includes Posts tab 2321 (displaying posts authored by user 1651), Files tab 2322 (providing access to files uploaded by user 1651), Profile tab 2323 (displaying profile information associated with user 1651), and Rooms tab 2324 (displaying an indication of Rooms having common membership between the current user and user 1651). When the user is finished with pane 2300, element 2325 can be selected to close pane 2300, thereby again fully revealing the group chat environment of region 1620.

Preferably, sliding pane 2300 overlays region 1620 to an extent that group chat user names or avatars in the underlying pane, such as avatar 1651, remain at least partially visible, as shown in FIG. 23. As described further hereinabove, the underlying pane 1620 remains active beneath pane 2300, such that selection of a different user indicia, such as avatar 1652, initiates display of a different user pane in region 2300, associated with user 1652 and defaulted into a private chat tab with that user. In that way, a user can rapidly cycle between private messaging with a variety of users who are in active conversation within region 1620, without having to close and re-open private chat panes or windows.

While certain system infrastructure elements are illustrated in particular configurations, it is understood and contemplated that functional elements described herein can be readily integrated and/or implemented via various alternative hardware or software abstractions, as would be known to a person of skill in the field of information systems design. For example, while some of the above described embodiments include presentation of content via a web browser, it is contemplated and understood that a standalone PC application, or a smart phone or tablet computer app, could be implemented in order to present content as described hereinabove. These and other variations are contemplated.

While depicted in the schematic block diagram of FIG. 14 as a block element with specific sub-elements, as known in the art of modern web applications and network services, server 1400 may be implemented in a variety of ways, including via distributed hardware and software resources and using any of multiple different software stacks. Server 1400 may include a variety of physical, functional and/or logical components such as one or more each of web servers, application servers, database servers, email servers, storage servers, XMPP or other instant messaging servers, and the like. That said, the implementation of server 1400 will include at some level one or more physical servers, at least one of the physical servers having one or more microprocessors and digital memory for, inter alia, storing instructions which, when executed by the processor, cause the server to perform methods and operations described herein.

While certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of any appended claims.

I claim:

1. A method performed by a user computing device interacting with a user, the method comprising:
generating, for presentation on the computer system, visual indicia of a plurality of messages within a chat message stream;
generating, for presentation on the computer system, a first user interface element which, when selected by the user, enables the user to identify one or more messages within the chat message stream for further action;
detecting selection of a second user interface element by the user, causing the computer system to initiate the generation of a post content item which may be associated with further content contributions contributed by a group comprising the user and other users, the post content item containing content from the one or more identified messages; and
displaying on the computer system a content group comprising the post content item.

2. The method of claim 1, in which the step of generating a first user interface element further comprises the substep of generating a first user interface element which, when selected by the user, enables the user to identify a plurality of non-contiguous messages within the chat message stream for further action.

3. The method of claim 1, in which the content group comprises the post content item and said further content contributions.

4. The method of claim 3, in which the step of displaying on the computer system a content group, further comprises the step of displaying on the computer system a plurality of content groups, sequenced in order of post content item creation.

5. The method of claim 3, in which the step of displaying on the computer system a content group, further comprises the step of displaying on the computer system a plurality of content groups, sequenced in order of most recent further content contribution.

6. A method performed by a user computing device interacting with a user to facilitate electronic communications with other individuals, the method comprising:
generating, for presentation on the computer system, visual indicia of messages within an electronic communication system;
generating, for presentation on the computer system, a first user interface element which, when selected by the user, enables the user to select a message; and
initiating the generation of a task item associated with the selected message.

7. The method of claim 6, in which the step of initiating the generation of a task item is further comprised of initiating the generation of a task item having a plurality of information fields, at least one of which is populated with default information associated with the selected message.

8. The method of claim 7, in which the plurality of information fields comprises a field populated by default with content from a body of the selected message.

9. The method of claim 6, in which the messages are email messages.

10. The method of claim 6, in which:
the messages are chat messages;
the step of generating a first user interface element comprises the step of generating, for presentation on the computer system, a first user interface element which, when selected by the user, enables the user to select a plurality of messages for further action; and
the step of initiating the generation of a task item comprises initiating the generation of a task item associated with each of the plurality of selected messages.

11. The method of claim 10, in which the step of initiating the generation of a task item is further comprised of initiating the generation of a task item having a plurality of information fields, at least one of which is populated with default information associated with the selected messages.

12. The method of claim 11, in which the plurality of information fields comprises a field populated by default with content from bodies of each of the plurality of selected messages.

13. A system for electronic communication hosted on one or more servers communicating with a plurality of user devices via one or more digital communication networks, the servers performing a method comprising:
hosting a chat service via which a plurality of users can exchange near-real time electronic messages in a chat stream, the messages being organized chronologically within the chat stream;
hosting of a content item posting service, the content item posting service enabling publication of one or more posts, each of which can be associated with further content contributions received from users of one or more of said plurality of user device;
receiving user input from a first user via communication between a user device associated with said first user and one or more of said servers, the user input to include specification of one or more messages within the chat stream and a request for generation of a new post; and
generating a new post within the content item posting service, containing content from the one or more specified messages.

14. The system of claim 13, in which the one or more messages within the chat stream comprises a plurality of nonadjacent messages within the chat stream.

15. The system of claim 13, in which the step of generating a new post within the content item posting service comprises:
transmitting an opening new post form prepopulated with content associated with the one or more specified messages;
receiving a committed new post form; and
using content within the committed new post form to generate the new post.

16. A system for electronic communication hosted on one or more servers communicating with a plurality of user devices, the servers configured to perform a method comprising:
storing a plurality of electronic messages;
receiving user input from a first user via communication between a user device associated with said first user and one or more of said servers, the user input to include specification of one of said plurality of electronic messages and a request for generation of a new task item; and
in response to receiving said user input, generating a task item within a task management service, the task item being associated with the selected message.

17. The system of claim 16, in which the task item comprises a plurality of information fields, at least one of which is populated with default information associated with the selected message.

18. The system of claim 17, in which the plurality of information fields comprises a field populated by default with content from a body of the selected message.

19. The system of claim 16, in which the messages are email messages.

20. The system of claim 16, in which:
the messages are chat messages;
the method further comprises, prior to the step of receiving user input, querying the first user for selection of a plurality of chat messages from which a task item is to be created; and in which
the step of generating a task item comprises generating a task item associated with each of the plurality of selected chat messages.

21. The system of claim 20, in which the step of initiating the generation of a task item is further comprised of initiating the generation of a task item having a plurality of information fields, at least one of which is populated with default information associated with each of the selected messages.

22. The system of claim 21, in which the plurality of information fields comprises a field populated by default with content from bodies of each of the plurality of selected messages.
